(19) United States
(12) Patent Application Publication
(10) Pub. No.: US 2017/0314421 A1
(43) Pub. Date: Nov. 2, 2017

(54) METHOD FOR OPERATING A TURBINE UNIT, STEAM POWER PLANT OR COMBINED-CYCLE POWER PLANT, AND USE OF A THROTTLING DEVICE

(71) Applicant: Siemens Aktiengesellschaft, Munich (DE)

(72) Inventor: Rainer Herberg, Mülheim (DE)

(73) Assignee: Siemens Aktiengesellschaft, Munich (DE)

(21) Appl. No.: 15/526,061

(22) PCT Filed: Nov. 11, 2015
(86) PCT No.: PCT/EP2015/076320

§ 371 Date: May 11, 2017

(30) Foreign Application Priority Data
Nov. 26, 2014 (EP) 14194852.1

(51) Int. Cl. F01K 13/02; F01K 7/02; F01D 9/04; F01K 7/32; F01K 23/10

(52) U.S. Cl. CPC F01K 13/02; F01K 7/32; F01K 23/101; F01D 9/041; F01K 7/025; F05D 2220/31

(57) ABSTRACT

A method for operating a turbine unit having at least two partial turbines, wherein a steam volumetric flow is conducted by a steam transfer device from the partial turbine arranged upstream to a partial turbine arranged downstream, which is connected after the partial turbine arranged upstream, wherein a pressure level within the steam transfer device is manipulated in accordance with a load range in which the turbine unit is operated, in such a way that the exhaust steam of the partial turbine arranged upstream remains superheated in the event of operation of the turbine unit in a partial-load range below the IGV point and/or in the event of a quick increase in the partial load.

### CROSS REFERENCE TO RELATED APPLICATIONS

This application is the US National Stage of International Application No. PCT/EP2015/076320 filed Nov. 11, 2015, and claims the benefit thereof. The International Application claims the benefit of European Application No. EP14194852 filed Nov. 26, 2014. All of the applications are incorporated by reference herein in their entirety.

### FIELD OF INVENTION

The invention relates to a method for operating a turbine unit comprising at least two part-turbines, in which a steam volume flow is guided by means of a steam crossover device from the part-turbine arranged upstream to a part-turbine arranged and connected downstream from said part-turbine arranged upstream.

The invention moreover relates to a steam power plant or a combined-cycle power plant with a turbine unit comprising at least two part-turbines which are operatively connected to each other by means of a common steam crossover device.

The invention furthermore relates to use of a throttling device provided at a steam crossover device arranged between two part-turbines.

### BACKGROUND OF INVENTION

Generic methods, turbine units, and steam power plants or combined-cycle power plants are already known from the prior art.

In particular, combined-cycle power plants are ideally predominantly operated in the full-load range because, inter alia, the optimal efficiency can consequently be achieved.

In order to be able to react better to changed market requirements in terms of the ever more flexible provision of electrical energy, more flexible operation in particular of such combined-cycle power plants is also increasingly required, wherein it is intended that their part-turbines are operated at least sometimes more often in lower part load ranges for lower energy generation but can be restored rapidly to full output when there is a short-term need for electrical energy.

Particularly in a static operating state, in particular combined-cycle power plants can be powered down to approximately 60% of their possible full load without the exhaust steam temperature of one of the part-turbines and hence also the steam inlet temperature of a downstream further part-turbine changing critically, or at least only to a negligible extent. However, this is the not case below the so-called IGV point, i.e. in a specific position of guide blades at the compressor inlet, because below this IGV point the exhaust steam temperature and/or steam inlet temperature can change to an undesired extent.

As well as fatigue caused to components of the turbines by the temperature change, in the case of some turbine configurations this can also result in unacceptable expansion into the wet steam region occurring. Owing to the wet steam and an associated critical development of wet steam, there is a risk of increased heat transfer, which can in turn occasion turbine blades to rub radially or axially against one another.

It should be understood that specifically the abovementioned circumstances significantly restrict the flexibility of operation in particular of combined-cycle power plants.

Furthermore, specifically with respect to an operating state, the problem can also result that the load can increase too quickly from part load to a critical jump in temperature inside the turbine, as a result of which the lifetime can be adversely affected. Although in theory the waste heat boiler could be sprayed in order to activate the turbine temperature in the event of an increase in load, so that at least a critical jump in temperature can consequently be limited, unacceptable and hence critical expansion into the wet steam region is likely specifically as a result of the load consumption. It is, however, essential that this be prevented for the abovementioned reasons.

### SUMMARY OF INVENTION

An object of the invention is to further develop generic methods and associated steam power plants or specifically combined-cycle power plants in such a way that they can be adapted, with low technical and structural complexity, to the elevated requirements in terms of more flexible provision of electrical energy.

This object is achieved by a method for operating a turbine unit comprising at least two part-turbines, in which a steam volume flow is guided by means of a steam crossover device from the part-turbine arranged upstream to a part-turbine arranged downstream, wherein a pressure level inside the steam crossover device is manipulated, depending on a load range generated by a turbine unit, in such a way that the exhaust steam of the part-turbine arranged upstream remains superheated in the event of the turbine unit being operated in a part load range below the IGV point and/or in the event of rapid increase in the part load.

The turbine unit can consequently be operated in an operationally secure manner down to lower part load ranges and/or adapted quickly to a significantly increased output or energy demand without there hereby being any risk that the exhaust steam in particular of the part-turbine arranged upstream expands critically into the wet steam region.

In this respect, the turbine unit and its part-turbines can be operated in an operationally secure manner outside the critical wet steam region.

In particular, in this connection, the expansion of the steam with respect to the part-turbine arranged upstream is shortened so that the associated exhaust steam remains superheated for longer and further and the risk of a critical development of wet steam at an undesired point in the turbine unit can thus also be prevented.

The pressure level, prevailing inside the steam crossover device, of the exhaust steam of the part-turbine arranged upstream is hereby raised by a corresponding extent.

Within the sense of the invention, the expressions “premature or critical expansion” and “critical development of wet steam” refer in particular to the development of wet steam outside desired areas of the part-turbine such as, for example, a low-pressure part.

Within the sense of the present invention, the term “lower part load ranges” describes part load ranges below the IGV point of the gas turbine.

Within the sense of the invention, the term “IGV point” refers to a specific position of the guide blades at the compressor inlet of the gas turbine, wherein this specific position results in low fuel consumption and low emission of pollutants. IGV stands for Inlet Guide Vanes and describes the adjustable guide blades at the compressor inlet of the gas turbine. The volume flow at the compressor inlet can be regulated by the guide blades.

The IGV point is the point at which the adjustable guide blades display their minimal opening and hence also a low volume flow. The IGV point represents the lowest operating point of the gas turbine at which the gas turbine can still be operated in an operationally secure and emission-compliant manner.

The term “rapid increase” describes an immediate increase in the turbine unit output of the gas turbine by, for example, more than 1% per minute.

The turbine units can thus be operated unproblematically in lower part load ranges without there being a risk that the exhaust steam in an undesired range of the turbine unit has already expanded into the wet steam region.

Furthermore, the turbine units operated in these lower part load ranges can be powered up more quickly again to close to the full-load range without there being a risk that the exhaust steam in an undesired range of the turbine unit has already expanded into the wet steam region.

In this respect, it is also advantageous if the exhaust steam of the part-turbine arranged upstream remains superheated in the event of operation of the turbine unit in a part load range below approximately 60% of the achievable full load.

The present turbine unit can comprise a wide range of different types of turbine such as, for example, gas turbines, steam turbines or high-pressure, medium-pressure, and/or low-pressure steam turbines, or hot-steam, wet-steam turbines, or the like.

Within the sense of the invention, the term “steam crossover device” describes any device by means of which superheated exhaust steam of a first part-turbine can cross over to a further part-turbine. Devices of this type can be designed, for example, as a crossover line or a crossover pipe or the like.

A variant of the method provides that the pressure level inside the steam crossover device is manipulated in such a way that premature expansion of the exhaust steam coming from the part-turbine arranged upstream into the wet steam region is prevented. As a result, the turbine unit and its part-turbines can be operated for longer outside the critical wet steam region, as a result of which it is obtained that the exhaust steam can expand into the wet steam region as much as possible only in ranges provided for this purpose.

It is moreover advantageous if the exhaust steam emerging from the part-turbine arranged upstream is maintained superheated as far as a low-pressure part so that critical expansion of the exhaust steam of the part-turbine arranged upstream into the wet steam region is prevented for as long as possible. Consequently, the turbine unit or its part-turbines can also be operated for longer outside the critical wet steam region.

In this respect it is advantageous if, depending on a load range at which the turbine unit is running, the steam volume flow in a steam crossover device is throttled in order to prevent the critical development of wet steam.

The manipulation of the pressure level performed within the sense of the invention can in particular be carried out in a structurally simple manner if the pressure level is manipulated by means of a control element arranged inside the steam crossover device. Such a control element can have a wide range of different structures, as is explained below.

The object of the invention is achieved, on the one hand, also by a steam power plant or a combined-cycle power plant with a turbine unit comprising at least two part-turbines which are operatively connected to each other by means of a common steam crossover device, wherein the steam power plant or the combined-cycle power plant has control and/or regulating means for controlling and/or regulating a pressure level and/or steam volume flow inside the common steam crossover device in order to influence wet steam behavior.

These control and/or regulating means employed at the common steam crossover device are used according to the invention to prevent critical wet steam in all part load ranges, as a result of which the effects already described in detail above can be obtained.

The object of the invention is, on the other hand, also achieved by a steam power plant or a combined-cycle power plant with a turbine unit comprising at least two part-turbines which are operatively connected to each other by means of a common steam crossover device, wherein the steam power plant or the combined-cycle power plant comprises means for preventing a critical development of wet steam, and wherein the means for preventing a critical development of wet steam are arranged at least partially inside the steam crossover device.

These means, employed inside the common steam crossover device, for preventing the critical development of wet steam are used according to the invention to prevent undesired wet steam in all the part load ranges, as a result of which the effects already described in detail above can likewise be obtained.

The abovementioned method according to the invention can in particular also be advantageously carried out by means of the steam power plants according to the invention and the combined-cycle power plants.

If the control and/or regulating means for controlling and/or regulating a pressure level or a steam volume flow, or means for preventing a critical development of wet steam depending on a load range operated by the turbine unit can be activated, an undesired development of wet steam can be prevented in a particularly operationally secure manner.

A further advantageous alternative embodiment provides that the steam power plant or the combined-cycle power plant comprises means for cooling or heating a waste heat boiler of the turbine unit, by means of which the waste heat boiler can be cooled or heated depending on a load range operated by the turbine unit. In particular, the method according to the invention is consequently also suited for transient operating states because the temperature at the part-turbine connected and arranged downstream can be kept low by suitable spraying of the waste heat boiler, or only permits a lower temperature gradient, whilst the control and/or regulating means or the means for preventing a critical development of wet steam ensure sufficient superheating of the exhaust steam of the part-turbine arranged upstream.

If the steam power plant or the combined-cycle power plant has a processing device by means of which the control and/or regulating means or means for preventing the critical development of wet steam, and means for cooling or heating a waste heat boiler of the turbine unit can be activated and operated in a coordinated manner, the turbine unit as a whole can be operated in a coordinated manner in order to be able to obtain the above-described effects in an operationally secure manner.

It should be understood that the abovementioned control and/or regulating means or the means for preventing the critical development of wet steam can take a structurally different form.

They can be integrated into a turbine unit in a particularly simple structural manner if the control and/or regulating means or means for preventing the critical development of wet steam have a throttle flap part or a throttle valve part of a throttling device.

The object of the invention is also achieved by use of a throttling device, provided at a steam crossover device arranged between two part-turbines, for preventing or at least curbing the critical development of wet steam.

In particular in the case of transient operating conditions, according to the invention the throttling device can be used to prevent critical development of wet steam at least partially or ideally completely.

Should the method according to the invention be carried out on a turbine unit which already a throttling device at the steam crossover device which seems to be suited to be employed within the sense of the invention, this turbine unit can be modified correspondingly simply in order to manipulate the pressure level inside the steam crossover device in particular depending on a load range operated by the turbine unit.

In particular, in the present case the use of such a throttling device for preventing critical wet steam is advantageous.

In the present case, the pressure level inside the steam crossover device can be manipulated specifically by the present turbine unit depending on a load range at which the turbine unit is running or depending on the above-described control and/or regulating means or means for preventing the critical development of wet steam.

As a result it is possible to reduce particularly reliably the risk that the exhaust steam coming from the part-turbine arranged upstream expands into the wet steam region too early if the turbine unit is operated in particular below a load range below the IGV point and/or a prevailing load is increased rapidly from a lower load range.

It is thus possible by means of the present invention to achieve lower part loads in an operationally secure manner and to significantly reduce the shortening of the lifetime of part-turbines of a turbine unit in particular in the case of transient processes.

In any case, the location of the development of wet steam can be shifted by means of the present invention, to be specific into the low-pressure part in which the development of wet steam is not critical.

It should be understood that the features of the solutions described above and in the claims can optionally also be combined in order to be able to realize the advantages correspondingly in a cumulative fashion.

Other features, effects, and advantages of the present invention are explained with the aid of the attached drawings and subsequent description, in which a turbine unit of a combined-cycle power plant equipped according to the invention is shown and described partially by way of example.

### BRIEF DESCRIPTION OF THE DRAWINGS

In the drawing:

FIG. 1 shows schematically a part view of a turbine unit, provided at a combined-cycle power plant, with two part-turbines operatively connected to each other by means of a steam crossover device, wherein a pressure level inside the steam crossover device is manipulated depending on a load range at which the turbine unit is running in such a way that the exhaust steam of the part-turbine arranged upstream remains superheated in the event of operation of the turbine unit in a part load range below the IGV point and/or in the event of a rapid increase in the part load; and

FIG. 2 shows schematically an h-s diagram of the combined-cycle power plant shown in FIG. 1.

### DETAILED DESCRIPTION OF INVENTION

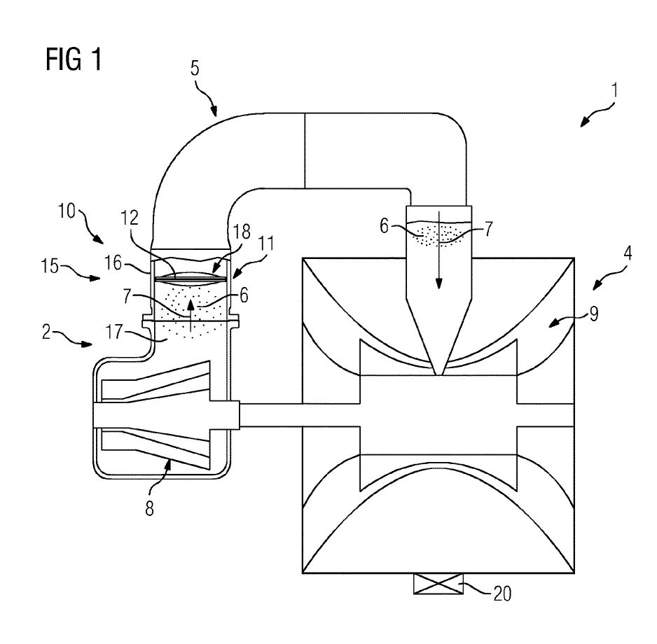

The combined-cycle power plant 1 shown in FIG. 1 has a turbine unit 2, only two part-turbines 3 and 4 of which are shown according to the view in FIG. 1.

These two part-turbines 3 and 4 are operatively connected to each other by means of a common steam crossover device 5 in such a way that exhaust steam 6 coming from the part-turbine 3 arranged upstream is guided as a steam volume flow 7 to the part-turbine 4 arranged further downstream so that the latter is operated by means of the exhaust steam 6 of the part-turbine 3 arranged upstream.

In this exemplary embodiment shown specifically in FIG. 1, the first part-turbine 3, i.e. the part-turbine 3 arranged upstream, is a medium-pressure steam turbine 8 and the second part-turbine 4, i.e. the part-turbine 4 arranged further downstream, is a low-pressure steam turbine 9.

According to the invention, the combined-cycle power plant 1 is characterized by a turbine unit 2 which has control and/or regulating means 10 for controlling and/or regulating a pressure level and/or a steam volume flow 7 inside the steam crossover device 5 in order to influence wet steam behavior, wherein these control and/or regulating means 10 in this exemplary embodiment comprise, in a structurally simple fashion, a throttling device 11 provided at the common steam crossover device 5, the throttle flap part 12 of which is arranged inside the common steam crossover device 5.

By means of this simply constructed control and/or regulating means 10 it is possible to obtain, as required, an increase in pressure with respect to the exhaust steam 6 at the present turbine unit 2 or at the combined-cycle power plant 1, in particular if the turbine unit 2 is operated in lower part load ranges below the IGV point, as a result of which it is constantly ensured that this exhaust steam 6 always remains superheated for as long as possible.

The same also applies in the event of a rapid increase in the part load, in particular from such lower part load ranges, wherein a waste heat boiler (not shown in detail here) can hereby be cooled by means (not shown further here) for cooling or heating the waste heat boiler of the turbine unit 2 in order to reduce the temperature at the part-turbine 4 connected and arranged downstream.

In this respect, this throttling device 11, with its throttle flap part 12 arranged in the common steam crossover device 5, also incorporates means 15 for preventing the development of wet steam inside the common steam crossover device 5 in order to achieve the above-described effects.

The throttling device 11 and its throttle flap part 12 are hereby arranged in an outlet support part 16 of the common steam crossover device 5 so that in particular the throttle flap part 12 is placed directly behind an exhaust steam outlet 17 of the part-turbine 3 arranged upstream.

In the present case, the throttle flap part 12 thus already incorporates a control element 18 by means of which the pressure level inside the common steam crossover device 5 can be manipulated within the sense of the present invention.

In order to be able to mutually employ the control and/or regulating means 10 and the means 15 for preventing the development of wet steam, and the means for cooling or heating the waste heat boiler of the turbine unit 2 in a coordinated manner, the turbine unit 2 also has a correspondingly designed processing device 20 which is designed such that the turbine unit 2 described here can be operated within the sense of the invention. This processing device 20 can hereby take the form of both hardware and software.

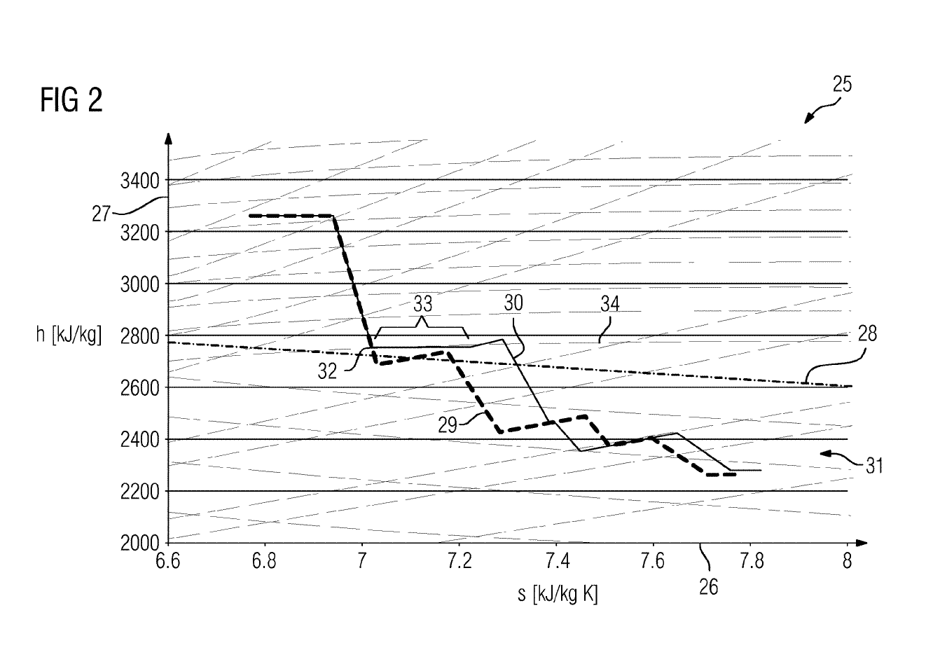

In the h-s diagram 25 shown in FIG. 2 for the turbine unit 2 shown at least partially in FIG. 1 of the combined-cycle power plant 1, the entropy values are plotted on the x-axis 26 and the enthalpy values on the y-axis 27, wherein the saturation curve 28 is clearly illustrated.

Also visible in this h-s diagram 25 is a usual expansion curve 29 with respect to expansion behavior of the exhaust steam 6 inside the common steam crossover device 5 without the use of the present control and/or regulating means 10 and the means 15 for preventing the development of wet steam in the event of operation of the turbine unit 2 in low part load operation below the IGV point of the turbine unit 2.

Drawn above this usual expansion curve 19 by way of example is a new expansion curve 30 of expansion behavior of the exhaust steam 6 inside the common steam crossover device 5 with the assistance of the present control and/or regulating means 10 and the means 15 for preventing the development of wet steam in the event of operation of the turbine unit 2 in low part load operation below the IGV point of the turbine unit 2.

It can be clearly seen that the turbine unit 2 can be operated outside the wet steam region 31 for much longer using the method proposed according to the invention. In other words, this means that the development of wet steam takes place at a location where it is desired, namely in the region of a low-pressure part.

Whilst the usual expansion curve 29 according to the view in FIG. 2 at the point 32 runs further toward the wet steam region 31, as a result of the use of the present control and/or regulating means 10 and the means 15 for preventing the development of wet steam at least temporarily, the new expansion curve 30 successfully runs from this point 32 for a stretch 33 in the sense of an isothermic change of state for a period essentially along an isotherm 34, as a result of which the exhaust steam 6 can expand for longer above the saturation curve 28 before the new expansion curve 30 runs again similarly to the usual expansion curve 29 in its continuation.

It should be explicitly pointed out at this point that the features of the solutions described above and in the claims can optionally also be combined in order to be able to realize or achieve the described features, effects, and advantages in a correspondingly cumulative manner.

Although the invention has been illustrated and described in detail in the preferred exemplary embodiment, the invention is not limited by this disclosed exemplary embodiment and other variants can be derived by a person skilled in the art without going beyond the scope of the invention.

1. A method for operating a turbine unit comprising at least two part-turbines, the method comprising:
guiding a steam volume flow by a steam crossover device from the part-turbine arranged upstream to a part-turbine arranged downstream and connected downstream from said part-turbine arranged upstream,
manipulating a pressure level inside the steam crossover device, depending on a load range at which the turbine unit is running, in such a way that the exhaust steam of the part-turbine arranged upstream remains superheated in the event of the turbine unit being operated in a part load range below the IGV point and/or in the event of rapid increase in the part load.

2. The method as claimed in claim 1,
wherein the pressure level inside the steam crossover device is manipulated in such a way that premature expansion of the exhaust steam coming from the part-turbine arranged upstream into the wet steam region is prevented.

3. The method as claimed in claim 1,
wherein, depending on a load range at which the turbine unit is running, the steam volume flow in a steam crossover device is throttled in order to prevent the critical development of wet steam.

4. The method as claimed in claim 1,
wherein the pressure level is manipulated by a control element arranged inside the steam crossover device.

5. A steam power plant or a combined-cycle power plant comprising:
a turbine unit comprising at least two part-turbines which are operatively connected to each other by a common steam crossover device, and
a controller or regulator for controlling and/or regulating a pressure level and/or steam volume flow inside the common steam crossover device in order to influence wet steam behavior.

6. The steam power plant or a combined-cycle power plant as claimed in claim 5, further comprising:
means for preventing a critical development of wet steam inside the common steam crossover device, and wherein the means for preventing the critical development of wet steam are arranged at least partially inside the common steam crossover device.

7. The steam power plant or combined-cycle power plant as claimed in claim 6,
wherein the controller or regulator for controlling and/or regulating a pressure level or a steam volume flow, or means for preventing a critical development of wet steam activates depending on a load range operated by the turbine unit.

8. The steam power plant or combined-cycle power plant as claimed in claim 6, further comprising:
means for cooling or heating a waste heat boiler of the turbine unit,
wherein the waste heat boiler is cooled or heated depending on a load range operated by the turbine unit.

9. The steam power plant or combined-cycle power plant as claimed in claim 8, further comprising:
a processing device which activates and operates in a coordinated manner the controller or regulator for controlling and/or regulating a pressure level or a steam volume flow, and/or the means for preventing the critical development of wet steam, and/or the means for cooling or heating a waste heat boiler of the turbine unit.

10. The steam power plant or combined-cycle power plant as claimed in claim 6,
wherein the controller or regulator for controlling and/or regulating a pressure level or a steam volume flow or the means for preventing the critical development of wet steam have a throttle flap part or a throttle valve part of a throttling device.

11. A method for preventing or at least curbing the critical development of wet steam, comprising:
using a throttling device,
wherein the throttling device is provided at a steam crossover device arranged between two part-turbines.

12. The steam power plant or a combined-cycle power plant as claimed in claim 6, adapted to implement a method for operating a turbine unit, wherein the method comprises:
guiding a steam volume flow by the steam crossover device from a part-turbine arranged upstream to a part-turbine arranged downstream and connected downstream from said part-turbine arranged upstream,
manipulating a pressure level inside the steam crossover device, depending on a load range at which the turbine unit is running, in such a way that the exhaust steam of the part-turbine arranged upstream remains superheated in the event of the turbine unit being operated in a part load range below the IGV point and/or in the event of rapid increase in the part load.
